(19) United States
(12) Patent Application Publication
(10) Pub. No.: US 2005/0241846 A1
(43) Pub. Date: Nov. 3, 2005

(54) EZ-LB electrical fitting

(76) Inventors: James Henry Finn III, Graham, WA (US); John Bernard Schatz, Puyallup, WA (US); Robert Forest Dew, Lakewood, WA (US)

Correspondence Address: Electric Connection, 5520-112th St. E. B2, Puyallup, WA, 98373, US

(21) Appl. No.: 10/836,416

(22) Filed: Apr. 29, 2004

(51) Int. Cl. H02G 3/08

(52) U.S. Cl. 174/50

(57) ABSTRACT

The EZ-LB is an electrical Conduit elbow in which conductors are pulled from one location to another location through the LB fitting at 90 degree angles toward each other. The design of the EZ-LB is for easier installation of conductors, consisting of a wider opening on the main body of the fitting. Allowing the conductors being installed to have a larger sending radius while being pulled through the fitting. The EZ-LB cover is secured weather tight when installed on the main body, using an interlocking lip and a grooved edge on both the cover and main body and only needing 1 screw to deem it tamper proof and secured to the main body.

### BACKGROUND OF INVENTION

The present invention, EZ-LB, relates to a PVC elbow electrical fitting used for interconnecting PVC non metallic conduit electrical conduits at 90 degree angles toward each other.

In U.S. Pat. No. 5,700,977 an electrical conduit fixture is disclosed for interconnecting PVC electrical non metallic conduit at 90 degree angles to each other.

The PVC elbow disclosed in this reference has many advantages over any other conduit fittings. The EZ-LB consists of only 2 pieces, the cover and main body with only 1 screw securing the cover to the main body and 1 interlocking tab at the opposite end of the cover to secure weather tight and immovable against the main body. No other parts or pieces are needed.

The shape and design of the cover and main body are key changes that are significant in the design of the EZ-LB for simplicity of wire installation.

### SUMMARY OF THE INVENTION

The purpose of the EZ-LB design is to allow the installation of the conductors through the fitting in an easier and shorter time.

The new design of the main body eliminated any possible damage to the conductors (insulation) during installation through the EZ-LB fitting. The EZ-LB, with the wider opening, will reduce the amount of time to install the conductors through the fitting due to the more open area around the conduit entrance fitting. In most cases of shorter conduit runs it will eliminate the use of an extra electrician during wire installation, saving the contractor time and money.

The cover is also redesigned; it is a one-piece cover with a locking latch at the top and single locking screw to the main body at the bottom. The cover is a tongue and groove type assembly, which creates a weather tight fit.

### BRIEF DESCRIPTION OF DRAWING

FIG. 1 This is an exploded view of the EZ-LB with the cover and main body in accordance with the present invention;

FIG. 2 EZ-LB cover and main body attached to each other complete of FIG. 1;

FIG. 3 EZ-LB end view showing conduit entrance opening with cover attached of FIG. 1;

FIG. 4 Top view of EZ-LB main body without cover of FIG. 1;

FIG. 5 EZ-LB end view looking into main body and opening for conduit exit without cover attached of FIG. 1;

FIG. 6 Side view of cover to main body of FIG. 1:

FIG. 7 Side view of EZ-LB main body of FIG. 1;

FIG. 8 Is a sectional view of the bottom side of the cover to EZ-LB fitting of FIG. 1.

### DETAILED DESCRIPTION OF THE PREFERRED EMBODIMENT

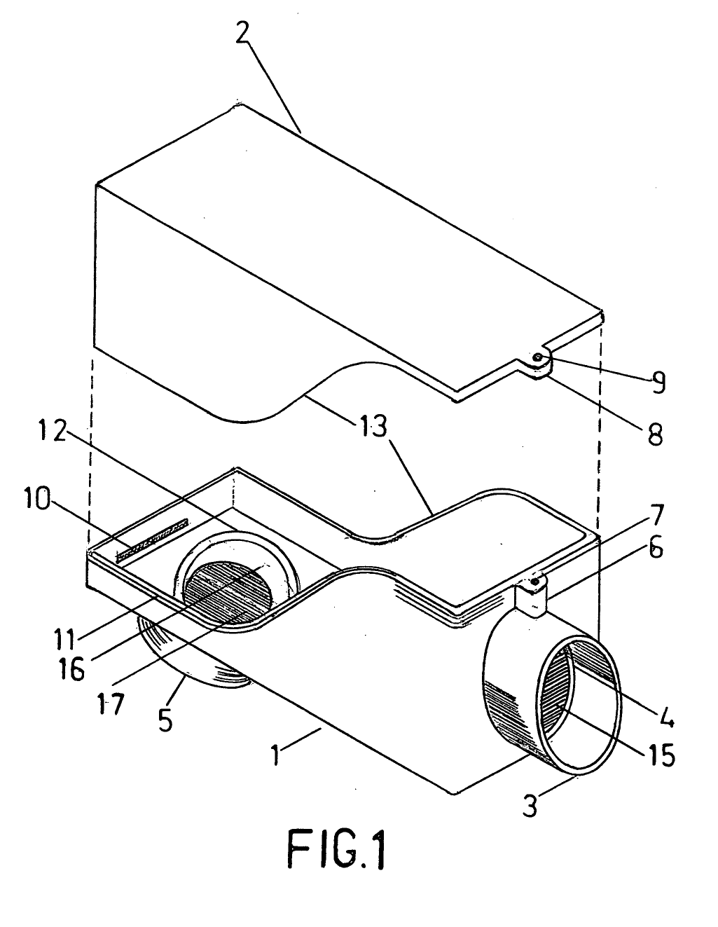

FIG. 1 present invention EZ-LB electrical fitting complete body 13 comprising of cover 2 and main body 1. The main body 1 consists of a general rectangular shaped member with conduit entrance opening 15 and conduit exit opening 17 with and conduit housing 3 and 5 which extend outwardly from main body 1 for conduit insertion and seating against beveled lip 4 and 12 so as not to extend into main body 1. The EZ-LB main body 1 also consists of screw housing 6 and thread screw hole 7 for fastening cover 2 securely to main body 1. Main body 1 consists of elongated groove 10 to interlock with tab 18 located on cover 2, to secure top end of cover 2 with main body 1 in a closed position. Referring to grooved edge 11 on main body 1 will allow cover 2 to seat properly with main body 1 to prevent water seepage into LB fitting 13. Cover 2 has protruding oval 8 with hole 9 that will set on top of screw housing 6 to allow screw (not shown) to be inserted into hole 9 and locked into thread hole 7 for tight and secure fit of cover 2 to main body 1 to complete LB fitting 13.

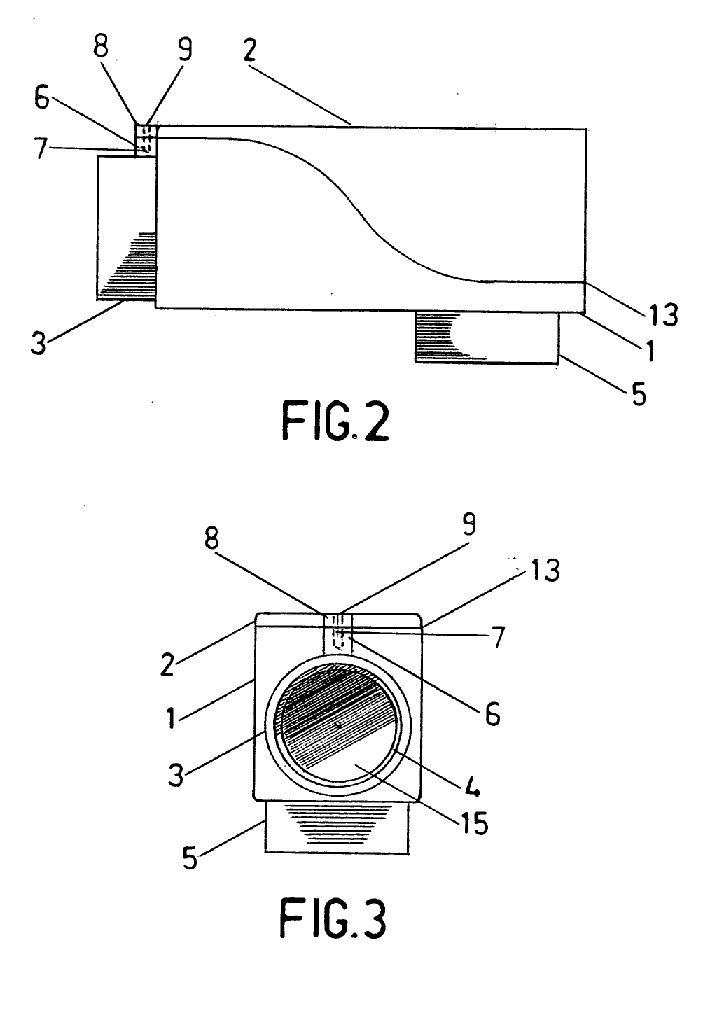

FIG. 2 reference is made to side view of complete LB 13 showing curved line of attachment on cover 2 to main body 1 and protruding PVC conduit housings 3 and 5 from main in body 1. Reference is also made to screw housing 6 attached to main body 1 and protruding oval 8 aligned with hole 9, for securing cover 2 with main body 1.

FIG. 3 reference is made to end view of complete body 13, looking into conduit entrance opening 15 while showing beveled lip 4 for preventing conduit from extending into main body 1. Beveled lip 4 is located on the inside of conduit housing 3 and 5. While looking at FIG. 3 you can see cover 2 seam against main body 1, also showing dotted line for screw hole 9 for screw to thread itself into hole 7 that will tighten secure against protruding oval 8 on cover 2 locking into screw housing 6 on main body 1, this sequence will allow cover 2 to be secured tight to main body 1 not allowing cover 2 to be dislodged from main body 1 (screw is not shown).

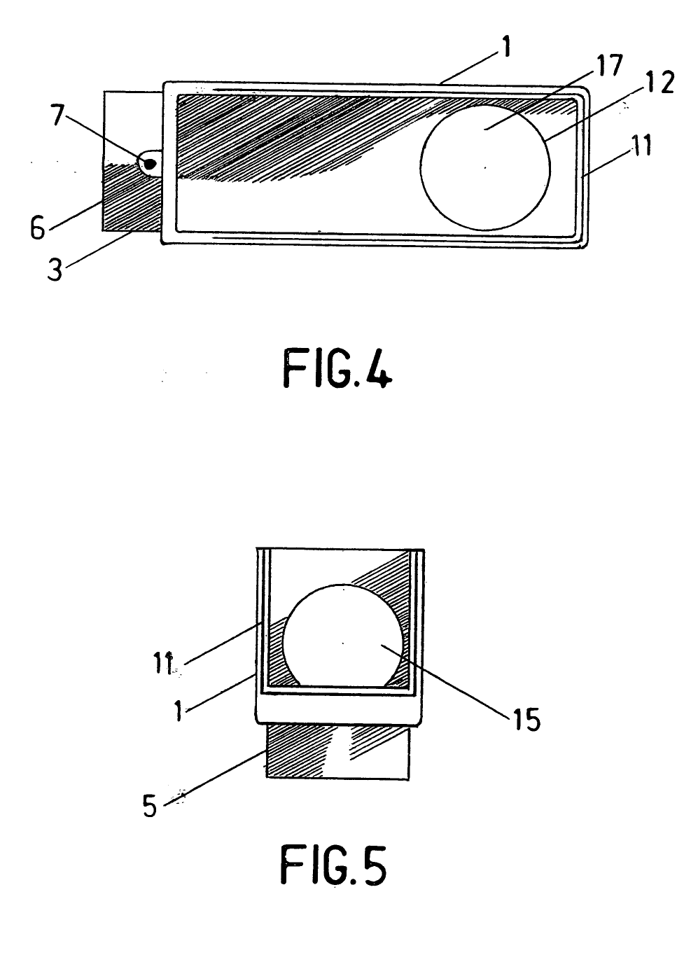

FIG. 4 is in reference to main body 1 top view looking into opening of main body 1 at the same time looking through conduit opening 17 with beveled lip 12 to prevent conduit from penetrating into conduit body 1. FIG. 4 also refers to threaded screw hole 7 embedded into center of screw housing 6 you can also see conduit housing 3. FIG. 4 is also showing grooved edge 11 used to interlock cover 2 onto main body 1 enabling the EZ-LB 13 to become weather tight when used outdoor.

FIG. 5 looking at end view of main body 1 through conduit opening 15 and extending perpendicular from main body 1 is conduit housing 5. You can also see grooved edge 11 cut into edge of main body 1 opening.

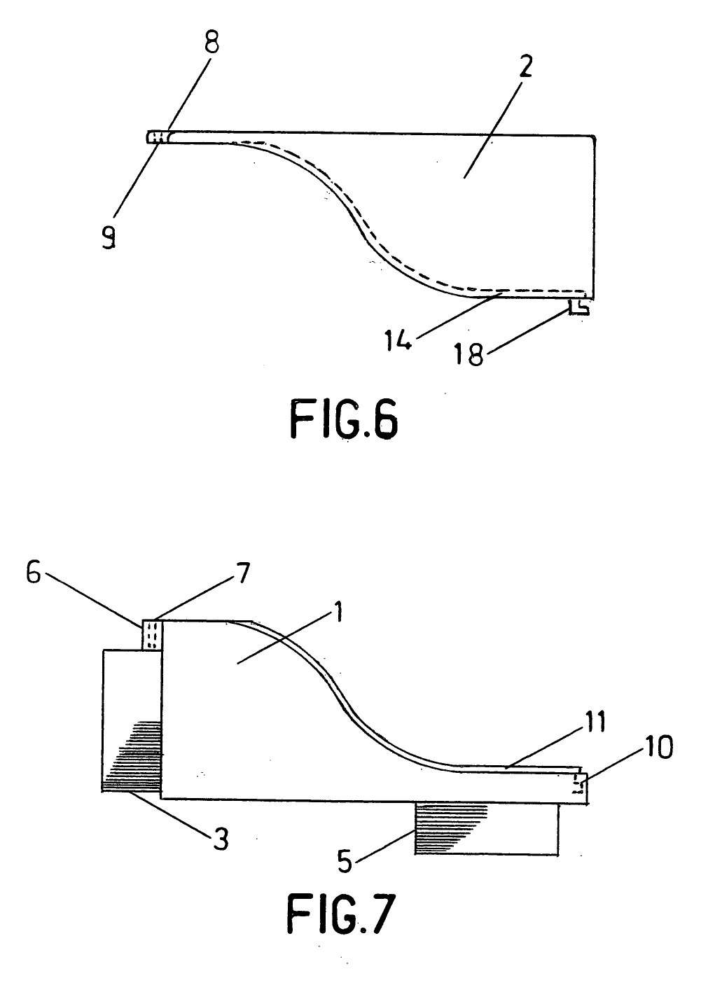

FIG. 6 looking at side view of cover 2 showing dotted line for grooved edge 14 on cover 2 and an excellent view of tab 18 that is molded into cover 2 for extra strength and long lasting durability. Tab 18 shall interlock into elongated groove 10 on FIG. 7 this procedure will allow the cover 2 and main body 1 to be secured and locked together forming complete body 12. The grooved edge 14 in the cover 2 FIG. 6 will at the same time seat with grooved edge 11 FIG. 7 when completing cover 2 with main body 1 in a locking position and finally securing it with a screw (not shown) into hole 9 on cover 2 FIG. 6 and threading the screw into threaded hole 7 on main body 1 FIG. 7.

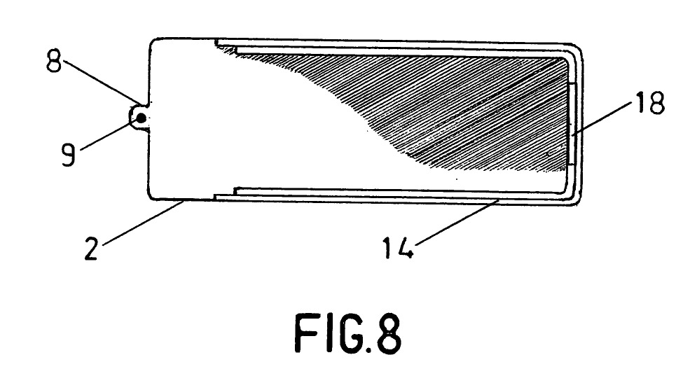

FIG. 8 is showing EZ-LB cover 2 inside view. Looking down on cover 2 you can see grooved edge 14 and interlocking tab 18 for securing cover to main body 1 on FIG. 1. Grooved edge 14 will interlock with grooved edge 11 on main body FIG. 7. This interlocking grooved edge 14 on cover 2 and grooved edge 11 on main body 1 will allow a weather tight seal without the need of gasket material.

### BACKGROUND OF INVENTION

The present invention, EZ-LB, relates to a PVC elbow electrical fitting used for interconnecting PVC non metallic conduit electrical conduits at 90 degree angles toward each other.

In U.S. Pat. No. 5,700,977 an electrical conduit fixture is disclosed for interconnecting PVC electrical non metallic conduit at 90 degree angles to each other.

The PVC elbow disclosed in this reference has many advantages over any other conduit fittings. The EZ-LB consists of only 2 pieces, the cover and main body with only 1 screw securing the cover to the main body and 1 interlocking tab at the opposite end of the cover to secure weather tight and immovable against the main body. No other parts or pieces are needed.

The shape and design of the cover and main body arc key changes that are significant in the design of the EZ-LB for simplicity of wire installation.

1. The EZ-LB is an electrical 90 degree conduit pulling elbow.

2. In conjunction with claim 2 the main body's shape and cover make it uniquely different than other junction fittings.

3. In conjunction with claim 3 the main Body's grooved edge allows the cover to fit weather tight without a gasket.

4. In conjunction with claim 4 the cover has an interlocking tab to secure it with the main body.

5. In conjunction with claim 5 the beveled edge at each conduit entrance shall be flush with the inside edge of the conduit.
